(19) United States
(12) Patent Application Publication
(10) Pub. No.: US 2008/0072566 A1
(43) Pub. Date: Mar. 27, 2008

(54) BLEED HOLES ORIENTED WITH GASPATH AND FLARED FOR NOISE REDUCTION

(75) Inventors: Andreas ELEFTHERIOU, Woodbridge (CA); David DENIS, Burlington (CA)

Correspondence Address: OGILVY RENAULT LLP (PWC), 1981 MCGILL COLLEGE AVENUE, SUITE 1600, MONTREAL, QC, H3A 2Y3, US

(73) Assignee: PRATT & WHITNEY CANADA CORP., Longueuil (CA)

(21) Appl. No.: 11/535,515

(22) Filed: Sep. 27, 2006

(51) Int. Cl. F02K 3/02

(52) U.S. Cl. 60/226.1; 60/785

(57) ABSTRACT

A gas turbine engine has a compressor assembly and a turbine assembly rotationally mounted on a shaft, the turbine assembly being driven by hot gases discharged from a combustion chamber disposed between the compressor and turbine assemblies and an engine case encasing a portion of the engine, the case having an oblong bleed hole having a major axis parallel to a gaspath direction and a minor axis perpendicular to the gaspath direction.

### TECHNICAL FIELD

The invention relates generally to gas turbine engines and, more particularly, to bleed-off holes for gas turbine engines.

### BACKGROUND OF THE ART

Gas turbine engines such as those used as aircraft turbojets or turbofans typically comprise a rotating fan, a low-pressure compressor and a high-pressure compressor as well as high-pressure and low-pressure turbines that are axially mounted to separate coaxial shafts for rotation about a central axis of the engine. The compressor and turbine assemblies are enshrouded within a turbofan case conventionally manufactured by joining together a number of flanged cases such as, for example, the fan case to the intermediate case, the gas generator case to the combustion chamber case, the combustion chamber case to the low-pressure turbine case, the low-pressure turbine case to the turbine exhaust case. One or more of these cases may have bleed-off holes for drawing off pressurized air into one or more bleed air systems or for exhausting air into the bypass duct. In certain engine designs, the bleed holes are prone to recirculation of bypass flow which cause resonance and acoustic noise. Furthermore, the bleed holes can sometimes give rise to excessive losses in the bypass.

Accordingly, there is a need to provide improved bleed-off holes that address one or more of these deficiencies.

### SUMMARY OF THE INVENTION

It is therefore an object of this invention to provide an improved bleed-off hole that is oriented, shaped an structured such that it reduces the likelihood of resonance and acoustic noise and/or the susceptibility to losses in the bypass.

In one aspect, the present invention provides a gas turbine engine having a compressor assembly and a turbine assembly rotationally mounted on a shaft, the turbine assembly being driven by hot gases discharged from a combustion chamber disposed between the compressor and turbine assemblies. The gas turbine engine also includes an engine case encasing a portion of the engine, the case having an oblong bleed hole having a major axis parallel to a gaspath direction and a minor axis perpendicular to the gaspath direction.

In another aspect, the present invention provides a monocase assembly for a gas turbine engine, the monocase assembly including a fan case portion for housing a fan rotor assembly and an intermediate portion connected to the fan case portion downstream of the fan case portion and connected to a gas generator portion upstream of the gas generator portion. The monocase assembly also includes a splitter mounted within the intermediate portion for splitting airflow between core flow and bypass flow, the splitter comprising a plurality of oblong bleed holes, each bleed hole having a major axis parallel to a gaspath direction and a minor axis perpendicular to the gaspath direction.

Further details of these and other aspects of the present invention will be apparent from the detailed description and figures included below.

### DESCRIPTION OF THE DRAWINGS

Reference is now made to the accompanying figure depicting aspects of the present invention, in which:

FIG. 1 is a schematic cross-sectional view of a turbofan as an example of a gas turbine engine that could incorporate embodiments of the present invention;

FIG. 2 is an exploded isometric view of a turbofan case having oblong bleed holes in accordance with an embodiment of the present invention;

FIG. 3A is an enlarged isometric view of oblong bleed holes in accordance with an embodiment of the present invention; and

FIG. 3B is a plan view of an oblong bleed hole showing major and minor axes.

### DETAILED DESCRIPTION OF THE PREFERRED EMBODIMENTS

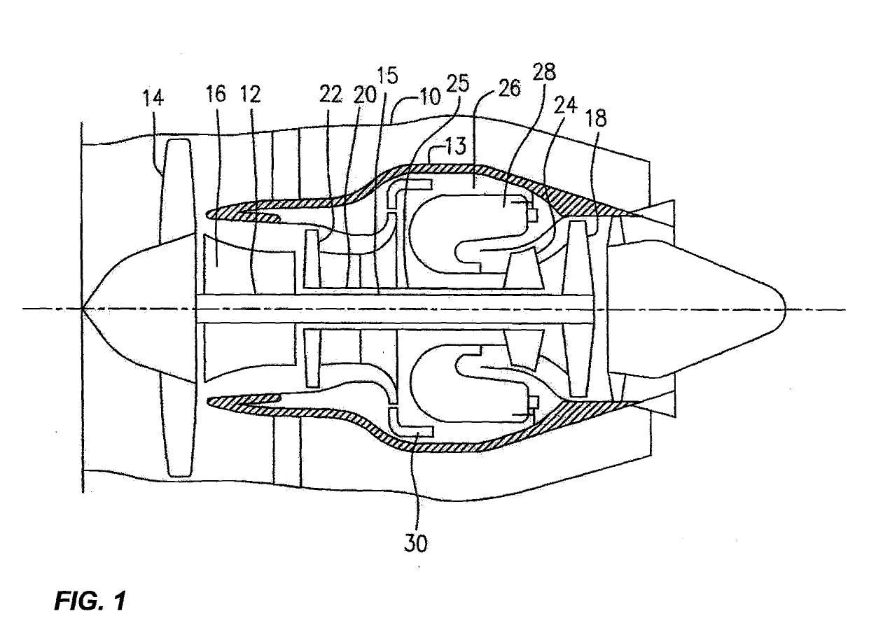

Referring to FIG. 1, a turbofan gas turbine engine incorporating an embodiment of the present invention is presented as an example of the application of the present invention, and includes a housing 10, a core casing 13, a low pressure spool assembly seen generally at 12 which includes a shaft 15 interconnecting a fan assembly 14, a low pressure compressor 16 and a low pressure turbine assembly 18, and a high pressure spool assembly seen generally at 20 which includes a shaft at 25 interconnecting a high pressure compressor assembly 22 and a high pressure turbine assembly 24. The core casing 13 surrounds the low and high pressure spool assemblies 12 and 20 in order to define a main fluid path (not indicated) therethrough. In the main fluid path there are provided a combustion section 26 having a combustor 28 therein. Pressurized air provided by the high pressure compressor assembly 22 through a diffuser 30 enters the combustion section 26 for combustion taking place in the combustor 28.

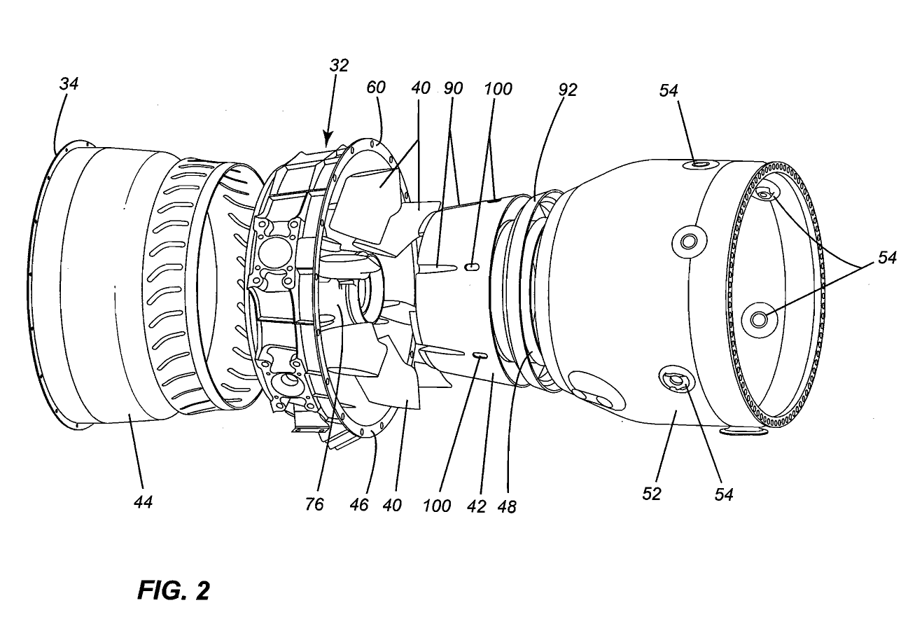

FIG. 2 illustrates, in an exploded view, a turbofan case 32 having a plurality of spaced-apart oblong bleed holes 100 in accordance with an embodiment of the present invention. The turbofan case 32 which, in this particular embodiment, is a monocase assembly includes an inlet 34, a fan case portion 44, which houses the fan rotor assembly 13, an intermediate portion 46 downstream of the fan case portion 44 and a gas generator portion 52 downstream of intermediate portion 46. The intermediate portion 46 includes a compressor shroud 48 which encircles the blade tips of the compressor assembly 16 as well as a splitter 42 for splitting the air flow into the core flow and the bypass flow. The gas generator portion 52 has a plurality of mounting points 54 to which other engine components can be mounted such as fuel injecting means (not shown).

As shown in FIG. 2, the intermediate portion 46 of case 32 also includes an inner hub 76. A flanged outer ring 60 is coaxial to the inner hub 76. A plurality of casing struts 40, which are circumferentially spaced apart as shown in this figure, extend radially outwardly and rearwardly from the inner hub 76 to the outer ring 60. A plurality of circumferentially spaced-apart slots 90 extend from the front face of the splitter rearward into the splitter 42 for receiving the respective casing struts 40.

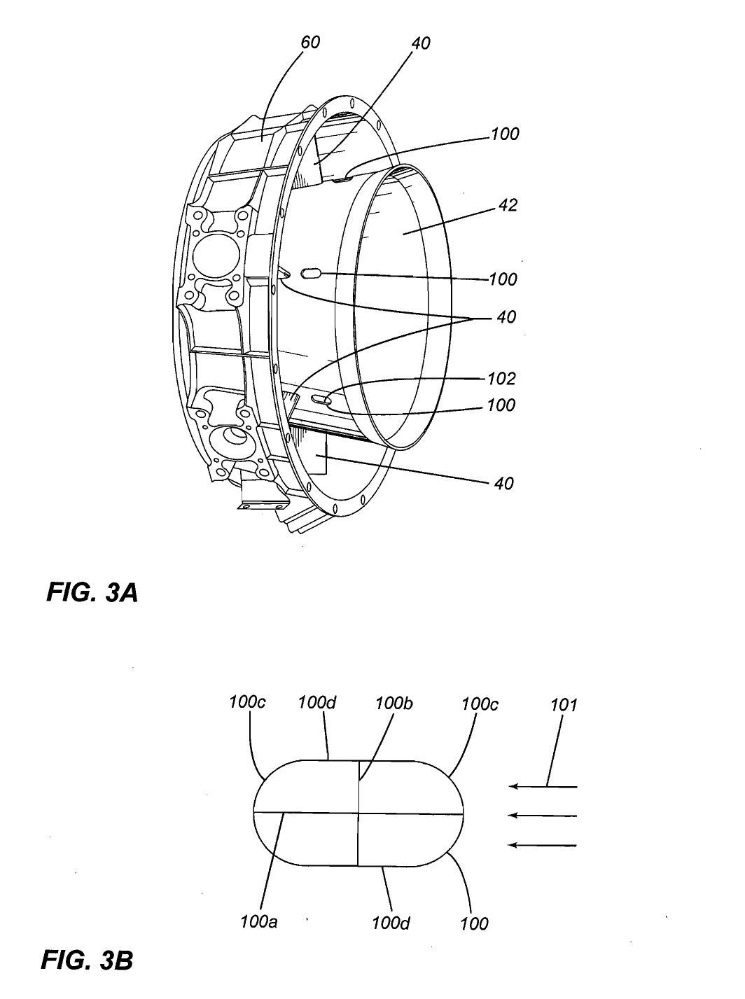

As illustrated in FIG. 2 and in the enlarged view of FIG. 3A, the bleed holes 100 are disposed in the splitter 42. As shown in FIG. 3B, the bleed holes 100 define an oblong opening having a major axis 100a parallel to a gaspath direction 101 and a minor axis 100b perpendicular to the gaspath direction 101. The gaspath direction means the predominant direction of air flow at that location in the engine. Oblong, for the purposes of this specification, means that the hole has a length that is greater than a width. Preferably, as shown in the figures, the oblong hole has ends 100c that are rounded to ensure smooth air flow. In the embodiment illustrated, the sides 100d of the oblong hole are parallel for most of the hole length although, in another embodiment, the oblong bleed holes can be elliptical, again having a major axis that is parallel to a gaspath direction and a minor axis perpendicular to the gaspath direction but in which the sides are curved to form an ellipse.

In the particular embodiment shown in FIG. 3A, the case 32 has a flared portion 102 at least partially surrounding a periphery of the bleed hole 100 to inhibit recirculation of bypass air flow. Without these flarings, air in the bypass is prone to recirculate via a cavity in the splitter (i.e. the air travels downstream, enters the splitter through a downstream hole, travels forward through the splitter and then recirculates into the bypass through an upstream hole, thus defining a recirculation path.) The flared portion effectively curtails this unwanted recirculation effect which can lead to resonance and acoustic noise.

In the embodiment illustrated in FIGS. 2 and 3A, each of the oblong bleed holes 100 is located in the splitter 42 immediately downstream of a respective casing strut 40. As noted above, each casing strut 40 extends through a forward portion of the splitter 42. In the particular embodiment shown in FIGS. 2 and 3A, the engine case 32 is a monocase assembly. Accordingly, each casing strut 40 extends radially from the inner hub 76 to the outer ring 60 of an intermediate portion of the monocase, with the flared and oblong (or elliptical) bleed holes 100 located behind each of the casing struts 40.

The above description is meant to be exemplary only, and one skilled in the art will recognize that changes may be made to the embodiments described without departing from the scope of the invention disclosed. For example, the impeller baffle can be used not only for turbofans or turbojets, but also for turboprops, turboshafts or any other gas turbine engine. Still other modifications which fall within the scope of the present invention will be apparent to those skilled in the art, in light of a review of this disclosure, and such modifications are intended to fall within the appended claims.

1. A gas turbine engine comprising:
a compressor assembly and a turbine assembly rotationally mounted on a shaft, the turbine assembly being driven by hot gases discharged from a combustion chamber disposed between the compressor and turbine assemblies; and
an engine case encasing a portion of the engine, the case having an oblong bleed hole having a major axis parallel to a gaspath direction and a minor axis perpendicular to the gaspath direction.

2. The gas turbine engine as defined in claim 1 wherein the oblong bleed hole is elliptical.

3. The gas turbine engine as defined in claim 1 wherein the case has a flared portion at least partially surrounding a periphery of the bleed hole to inhibit recirculation of bypass air flow.

4. The gas turbine engine as defined in claim 2 wherein the case has a flared portion at least partially surrounding a periphery of the bleed hole to inhibit recirculation of bypass air flow.

5. The gas turbine engine as defined in claim 1 wherein the bleed hole is located in a splitter immediately downstream of a casing strut extending radially through a forward portion of the splitter.

6. The gas turbine engine as defined in claim 2 wherein the bleed hole is located in a splitter immediately downstream of a casing strut extending radially through a forward portion of the splitter.

7. The gas turbine engine as defined in claim 3 wherein the bleed hole is located in a splitter immediately downstream of a casing strut extending radially through a forward portion of the splitter.

8. The gas turbine engine as defined in claim 4 wherein the bleed hole is located in a splitter immediately downstream of a casing strut extending radially through a forward portion of the splitter.

9. A monocase assembly for a gas turbine engine, the monocase assembly comprising:
a fan case portion for housing a fan rotor assembly;
an intermediate portion connected to the fan case portion downstream of the fan case portion and connected to a gas generator portion upstream of the gas generator portion; and
a splitter mounted within the intermediate portion for splitting airflow between core flow and bypass flow, the splitter comprising a plurality of oblong bleed holes, each bleed hole having a major axis parallel to a gaspath direction and a minor axis perpendicular to the gaspath direction.

10. The monocase assembly as defined in claim 9 wherein the oblong bleed hole is elliptical.

11. The monocase assembly as defined in claim 13 wherein the splitter has a flared portion at least partially surrounding a periphery of the bleed hole to inhibit recirculation of bypass air flow.

12. The monocase assembly as defined in claim 10 wherein the splitter has a flared portion at least partially surrounding a periphery of the bleed hole to inhibit recirculation of bypass air flow.

13. The monocase assembly as defined in claim 9 wherein the bleed hole is located in the splitter immediately downstream of a casing strut extending radially through a forward portion of the splitter.

14. The monocase assembly as defined in claim 10 wherein the bleed hole is located in the splitter immediately downstream of a casing strut extending radially through a forward portion of the splitter.

15. The monocase assembly defined in claim 11 wherein the bleed hole is located in the splitter immediately downstream of a casing strut extending radially through a forward portion of the splitter.

16. The monocase assembly as defined in claim 12 wherein the bleed hole is located in the splitter immediately downstream of a casing strut extending radially through a forward portion of the splitter.
